(19) United States
(12) Patent Application Publication
(10) Pub. No.: US 2017/0265262 A1
(43) Pub. Date: Sep. 14, 2017

(54) DUAL CIRCUIT LED LIGHT SOURCE

(71) Applicant: Robert F. Fiermuga, Glenview, IL (US)

(72) Inventor: Robert F. Fiermuga, Glenview, IL (US)

(21) Appl. No.: 15/067,374

(22) Filed: Mar. 11, 2016

(51) Int. Cl. H05B 33/08; F21V 23/02; F21V 23/06; H05B 37/02; F21V 19/00

(52) U.S. Cl. CPC H05B 33/0845; H05B 37/0272; F21V 19/005; F21V 23/06; F21V 23/02; H05B 37/0281; F21Y 2115/10

(57) ABSTRACT

A multi-level lighting system which utilizes efficient first and second light sources for energy savings and/or ambiance. This invention combines at least two sets of LEDs on a single light engine to provide multi-level lighting while keeping the circuits of the LED sets electrically separate or isolated.

### BACKGROUND OF THE INVENTION

Field of the Invention

This invention is directed to a solid-state lighting device, such as light emitting diode (LED) device, for illumination at one, two, and/or more lighting levels, such as for energy conservation and/or other dual level lighting.

Discussion of Related Art

Emergency egress lighting for use during power failures can include first and second light source systems. In general, these systems have a first light source which is powered off the electrical grid and provides ample luminance for normal operation. A second emergency light source can provide at least a minimum luminance for an extended duration, until the first light source is working. In these dual purpose egress lighting systems, the first light source needs to provide specified lighting parameters, while the second light source needs to provide a minimum level of lighting for an extended duration.

Multi-level level lighting can be useful for other reasons, such as energy conservation or for improved ambiance. There is a continuing need for an improved lighting system which utilizes an efficient light source, such as LEDs, with the purpose of providing dual lighting levels.

### SUMMARY OF THE INVENTION

This invention relates to an improved multi-level lighting system which utilizes a solid state light source, such as LEDs. The invention includes a lighting device with two or more sets of LEDs on a single circuit board in order to provide bi-level or multi-level lighting device, while keeping the circuits of the LED lighting sources electrically separate or isolated.

The invention includes a solid state lighting device having a circuit board. A first light source and a second light source are provided, with each including an LED electrically connected to the circuit board. The lighting device further includes a first electrical connection for connecting a first powersource with the first light source through the circuit board, and a second electrical connection for connecting first or a second power source with the second light source through the circuit board. The first light source and the second light source can have different light outputs and can be powered together or separately to provide more than one lighting level from the device.

The invention further includes a solid state lighting device with a circuit board including a first circuit and a second circuit, where the first circuit is electrically separate from the second circuit. The first circuit includes a first electrical connection for connecting a power source with the first circuit. The second circuit includes a second electrical connection for connecting the power source and/or a second power source with the second circuit. The lighting device includes a first light source with at least one LED, and desirably a plurality of LEDs, electrically connected to the first circuit, and a second light source including at least one LED, and desirably a plurality of LEDs, electrically connected to the second circuit. The second light source has a light output that can be equal to, or less than a light output of the first light source.

With the first and second light sources having different light outputs, more than two lighting levels can be obtained: the first alone, the second alone, and the first and second light sources combined. Additional individual and separate light sources can provide addition lighting levels.

The invention further includes a method of saving energy with the lighting device in a light fixture or housing. The method includes providing a circuit board having the desired LED configuration and a size to fit within the fixture or housing. Each of the first and second light sources is separately connected to an AC power source or to wiring in the light fixture or housing for connecting to the AC power source. The first light source is powered during a first time period, and the second light source is powered during a second time period that is at least partially different from the first time period. The second light source has a lower power requirement from the first light source to provide the energy saving over the use of the first light source.

The lighting device of this invention can be used as a dual light source for newly manufactured light fixtures or for retrofitting into existing light fixtures, thereby providing an energy-saving lighting system without requiring additional fixtures.

Other objects and advantages will be apparent to those skilled in the art from the following detailed description taken in conjunction with the appended claims and drawings.

### BRIEF DESCRIPTION OF THE DRAWINGS

FIG. 1 is a top view of a lighting device according to one embodiment of this invention.

FIG. 2 is a sectional side view of a lighting device according to one embodiment of this invention.

FIGS. 3 shows a lighting device having alternative LED array according to an additional embodiment of this invention.

FIG. 4 illustrates a general schematic of an exemplary wiring diagram according to one embodiment of this invention.

### DETAILED DESCRIPTION OF THE INVENTION

The present invention provides a multi-circuit lighting device which utilizes solid state light sources, such as LEDs. The invention includes at least two LED light sources on a single circuit board for use in manufacturing new lighting devices or retrofitting existing lighting devices.

FIG. 1 is a schematic of a bi-level or dual circuit lighting device 10 having both a first lighting functionality and a different second lighting functionality, according to one embodiment of this invention. The lighting device 10 includes a first light source 12 and a second light source 14 which are both wired to a circuit board 15 to form a combined or common light engine, and each including at least one light emitting diode (LED). The first light source 12 includes three rows of a plurality of LEDs 16, with five individual LEDs in each row. The second light source 14 includes two rows of a plurality of LEDs 18, each between two adjacent rows of the first light source 12 and each with four individual LEDs in each row.

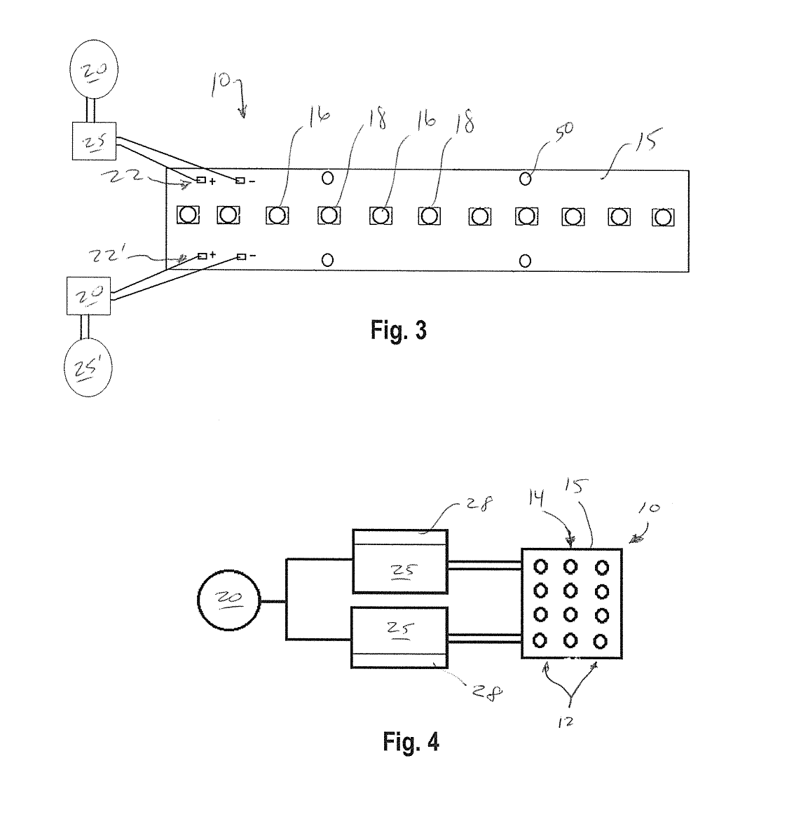

The LEDs of each of the light sources can vary in number and/or light output, and can have various and alternative patterns, such as circular, wavy, or other shaped pattern. The pattern of the first and second light sources can also be different sizes or shapes, such as a smaller circle within a larger circle, and/or be located on different sides of the circuit board. FIG. 3 illustrates one such alternative, with a single row of LEDs with alternating LEDs of the first and second light sources. Every other LED, or every other two LEDs, etc., is on the circuit for the first light source and the LEDs in between are on the second light source circuit. Other placement combinations or patterns are also available, such as a single second light source LED can alternative be placed between adjacent sets of two LEDs of the first light source.

The first light source 12 is in electrical connection with the circuit board 15. As used herein, the term “electrical connection” or “electrically connected” refers to a connection between elements that allows electrical power to pass from one element to the other. The first light source 12 can be provided as a light source for use alone and/or in combination with the second light source 14 in lighting devices to provide adequate light to allow the normal desired activity in an area. The first light source 12 includes a first electrical connection 22 for connecting the first light source 12 to a power source 20. The first electrical connection 22 can be any suitable connection that allows the transfer of electrical power from the power source 20 to the circuit board 15, via wiring, and ultimately to the LEDs 16 of the first light source 12. In one embodiment of this invention the first electrical connection 22 includes a surface to which wiring connected to the first power source 20 can be soldered to the circuit board 15. However, various other electrical connectors known to those skilled in the art of electrical wiring and circuits can be used as well.

The power source 20 desirably includes a steady source of power that provides consistent power for serving as at least a portion of the first lighting of an area for normal operations. In one embodiment, the power source 20 is an alternating current power source such as from an electrical grid. However, the power supply 20 may be or include any primary and/or secondary power supply that can provide sufficient power, including but not limited to a battery and/or a generator. The electrical connection between the power supply 20 and the first light source 12 can include resistors and other components as needed, based upon the electrical characteristics of the power supply 20 and the electrical characteristics of the first light source 12.

The second light source 14 is also in electrical connection with the circuit board 15. In embodiments of this invention, the first light source 12 is electrically separate or isolated from the second light source 14 so that electricity cannot flow from one of the circuits to the other. The second light source 14 includes a second electrical connection 22′ for connecting the second light source 14 to the power source 20 or a second power source. The second electrical connection 22′ can also be any suitable connection that allows the transfer of electrical power from the power source 20 to the circuit board 15, via wiring, and ultimately to the LEDs 18 of the second light source 14. The circuit board 15 thus includes two circuits. A first circuit connects the electrical connectors 22 to each of the LEDs 16 of the first light source 12, and a second circuit connects the electrical connectors 22′ to each of the LEDs 18 of the second light source 14.

The second light source 14 is provided for use alone or in combination with the first light source 12. In one embodiment of this invention, the second light source 14 has a light output or power rating that is less than the first light source 12, and the second light source 14 serves to provide a multi-level light output, such as to provide a brighter setting when used in combination with the first light source 12, or to be used alone to provide a lower lighting level for ambiance, energy savings, and/or emergency or safety lighting. In one embodiment of this invention, the power source 20 or a second power source powers the second light source 14 upon the interruption of the first light source 12. The interruption of the light source 12 can be, for example, for ambiance, due to a poweroutage, for energy savings or simply a customary manual shutdown of the first light source 12, such as at the end of a work day in an office building. By remaining on when the electrical current to the first light source 12 is interrupted, the second light source 14 provides a lower desired light level.

In some embodiments of this invention, the switching between the two light sources 12 and 14 is performed by components external to the circuit board 15. As shown in FIG. 1, the electrical connections 22 desirably each include a respective LED driver 25 and 25′. Each of the LED drivers 25 and 25′ desirably converts higher voltage, alternating current from the power source 20 to low voltage, direct current for powering the LEDs, keeps the voltage and current flowing through the LED circuits at the appropriately rated level, and/or provides other functions as are known in the art.

The LED drivers 25 and 25′ of embodiments of this invention can each or both include or be in electrical contact with a combined or individual controller, such as or including a switch, that allows for operation with the corresponding light source. The controller can operate one or more lighting devices. In some embodiments of this invention, the controller includes a network and/or wireless connection and functionality that allows for manual and/or automated wireless operation, such as over the Internet and/or by Bluetooth® or WiFi®. A user or data processor can control (e.g., turn on/off) the first and/or second light sources by remote device, such as a mobile device application, to control the level of the lighting. FIG. 4 illustrates a schematic where each of two light sources is powered by the same power source 20, through its own LED driver 25, respectively. Each LED driver 25 includes an integral or separately connected controller 28. As will be appreciated, the wiring schematic is intended to be general and not limiting, as other wiring and/or controller configurations can be used to provide the multi-level lighting device of this invention.

In one embodiment of this invention, the lighting device 10 can be used to provide emergency egress lighting. The lighting device 10 can also be combined with a second similar lighting device or other emergency egress lighting device, such that the combination provides sufficient luminance to comply with the emergency egress lighting requirements, such as required by NEC or other standards.

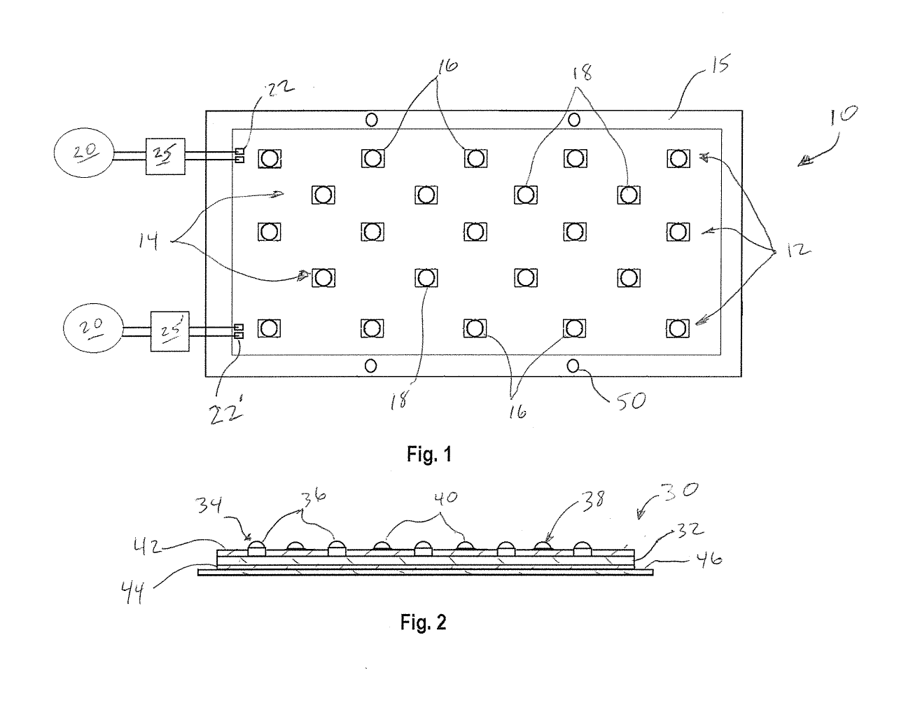

FIG. 2 shows a sectional view, not to scale, of a lighting device 30 according to one embodiment of this invention. The lighting device includes a circuit board 32, a first light source 34 including LEDs 36 electrically connected to the circuit board 32, and a second light source 38 including LEDs 40 also electrically connected to the circuit board 32. The LEDs 40 are less in number and/or combined total wattage than the LEDs 36, thereby providing the second light source 38 with a light output less than the first light source 34. As will be appreciated, the amount of LEDs and/or light output of the two light sources can be the same if desired, but energy savings or ambiance would require a lower LED number, voltage, and/or output.

In some embodiments of this invention, the circuit board 32 includes or is formed as a flexible circuit. Various types of flexible circuits are available for use as circuit 32, such as single sided flex circuits, dual access flex circuits, double sided flex circuits, or multi-layer flex circuits. The flexible circuit includes a conductive circuit, such as a printed circuit, on a flexible substrate. The flexible substrate can be any suitable substrate, and preferably includes a sheet, film, or fabric made from or including a metal or plastic such as, without limitation, polyimide, polyester, polyethylene napthalate, or combinations thereof. The conductive circuit can be formed including any suitable known circuit material, such as copper or silver, and applied by any known application process, such as printing or lamination. One such suitable flexible circuit is made by Metrospec Technology, LLC (Mendota Heights, Minn.) under the trade name FlexRAD.

The lighting device 30 shown in FIG. 2 includes a circuit coating 42 over the printed circuit 32. The coating 42 can be used to provide a protection layer over the circuit. Films and solder masks are exemplary protective circuit coatings for use in this invention. A solder mask is commonly a lacquer-like layer of polymer that provides a permanent protective coating for the circuit and prevents solder from bridging between conductors.

The lighting device 30 further includes an adhesive layer 44 coating some of or the entire back surface of the circuit substrate 32 that is opposite the protective coating 42. The adhesive coating 44 can be used to apply the lighting device 30 to a surface, such as in a light fixture or housing. The adhesive material is desirably a heat dissipating material, such as 8810 material available from 3M Corporation (St. Paul, Minn.). In embodiments where the flexible circuit includes a thin metal substrate, the adhesive material can also act to electrically isolate or insulate the flexible circuit from, for example, other components of the lighting fixture or housing into which the lighting device is installed.

In one embodiment of this invention, the flexible circuit 32 is adhered to a further, more rigid substrate for support and/or installation purposes. The rigid substrate can be for example, a heat sink for dissipating heat, a shaped board for use in installation, or a combination thereof. In FIG. 2, the rigid substrate 46 has a shape adapted to be installed in a fixture or housing. The rigid substrate 46 illustrated extends beyond one or more sides of the flexible circuit 32, which can be useful for including mounting holes, such as mounting holes 50 shown in FIG. 1.

Desirably, the lighting device of this invention includes a patterned LED array. The first and second light sources can have different patterned LED arrays, but desirably each of the first light source and second light source are included in or part of a single patterned LED array, such as to provide a balanced and/or aesthetically pleasing lighting device. FIGS. 1 and 2 illustrate an LED grid array, which refers to a layout of LEDs on a square or rectangular grid with a separation between adjacent LEDs of a predetermined distance in each direction.

Thus, this invention provides a multi-level lighting system from a single light engine which utilizes an efficient first and second light source each usable alone or in combination to provide various levels of light output. The lighting device of this invention can be used as a multi-level light source for newly manufactured light fixtures or for retrofitting into existing light fixtures, thereby providing an energy-saving lighting system without requiring additional fixtures.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A bi-level solid state lighting device, comprising:
a circuit board;
a first light source including a first plurality of light emitting diodes electrically connected to the circuit board;
a second light source including second plurality of light emitting diodes electrically connected to the circuit board;
a first electrical connection for connecting a first power source with the first light source through the circuit board; and
a second electrical connection for connecting the first power source or a second power source with the second light source through the circuit board;
wherein the first light source and the second light source can be powered together or separately to provide more than one lighting level from the device.

2. The lighting device according to claim 1, wherein the first power source comprises an alternating current power source.

3. The lighting device according to claim 1, wherein each of the first and second electrical connection comprises a wirelessly operated switch.

4. The lighting device according to claim 1, further comprising a patterned LED array, wherein each of the first light source and second light source are included in a pattern of the patterned LED array.

5. The lighting device according to claim 1, wherein the circuit board comprises parallel rows of LED, wherein at least one row of LEDs of the second light source is disposed between two rows of LEDS of the first light source.

6. The lighting device according to claim 1, wherein the circuit board comprises a flexible circuit.

7. The lighting device according to claim 6, wherein the circuit board comprises a conductive circuit printed on a flexible metal or plastic substrate.

8. The lighting device according to claim 7, further comprising a circuit coating, the conductive circuit disposed between the substrate and the circuit coating.

9. The lighting device according to claim 6, further comprising an adhesive backing on the substrate.

10. The lighting device according to claim 6, further comprising a rigid substrate including an attachment opening for attaching the rigid substrate to a light fixture or housing, wherein the flexible substrate is adhered to the rigid substrate.

11. A method of saving energy with the lighting device according to claim 1 in a light fixture or housing, the method comprising:
obtaining a circuit board having a size to fit within the fixture or housing;
connecting the first light source to an AC power source or to wiring in the light fixture or housing for connecting to the AC power source;
connecting the second light source to the AC power source or to the wiring in the light fixture or housing for connecting to the AC power source;
fixing the circuit board to the fixture or housing;
powering the first light source during a first time period; and
powering the second light source during a second time period that is at least partially different from the first time period, wherein the second light source has a lower power requirement from the first light source.

12. A solid state lighting device, comprising:
a circuit board including a first circuit and a second circuit, the first circuit electrically separate from the second circuit;
the first circuit including a first electrical connection for connecting a first power source with the first circuit;
the second circuit including a second electrical connection for connecting the first power source or a second power source with the second circuit;
a first light source including a plurality of light emitting diodes electrically connected to the first circuit; and
a second light source including at least one light emitting diode electrically connected to the second circuit, the second light source having a light output that is different than the first light source;
wherein the second light source is separately controllable from the first light source.

13. The lighting device according to claim 12, wherein the first power source comprises an alternating current power source.

14. The lighting device according to claim 13, wherein each of the first electrical connection and the second electrical connection comprises a separately operable switch.

15. The lighting device according to claim 14, wherein each of the first electrical connection and the second electrical connection include a wireless controller that is operated by a wireless signal from a remote actuator.

15. The lighting device according to claim 12, further comprising a patterned LED array, wherein each of the first light source and second light source are included in a pattern of the patterned LED array.

17. The lighting device according to claim 12, wherein the circuit board comprises parallel rows of LED, wherein each of a plurality of row of LEDs of the second light source is disposed between two rows of LEDS of the first light source.

18. The lighting device according to claim 12, wherein the circuit board comprises a flexible circuit including a conductive circuit printed on a flexible metal or plastic substrate.

19. The lighting device according to claim 17, further comprising a circuit coating, the conductive circuit disposed between the substrate and the circuit coating.

20. The lighting device according to claim 17, further comprising a rigid substrate including an attachment opening for attaching the rigid substrate to a light fixture or housing, wherein the flexible substrate is adhered to the rigid substrate.
